(19) United States
(12) Patent Application Publication
(10) Pub. No.: US 2006/0239796 A1
(43) Pub. Date: Oct. 26, 2006

(54) Cable tie with fir-tree type fastener

(76) Inventor: John R. Franks, Hopkinton, MA (US)

Correspondence Address: KRIEGSMAN & KRIEGSMAN, 665 Franklin Street, Framingham, MA, 01702, US

(21) Appl. No.: 11/244,876

(22) Filed: Oct. 6, 2005

Related U.S. Application Data
(60) Provisional application No. 60/673,221, filed on Apr. 20, 2005.

(51) Int. Cl. F16M 13/00; F16L 3/12

(52) U.S. Cl. 411/455; 248/615; 248/74.3

(57) ABSTRACT

A one-piece cable tie includes a locking head and an attached strap, the locking head being adapted to receive and selectively engage a portion of the strap when the tie is formed into a closed loop. The cable tie additionally includes a fir-tree fastener formed onto the locking head, the fastener being sized and shaped to be fittingly inserted through a quarter-inch circular opening in a panel. The fastener includes a stem and a plurality of flutes formed onto the stem in such a manner so as not to interfere with one another when the fastener is being fittingly inserted through the opening in the panel. Because the fastener does not experience flute interference when inserted through a panel opening, the fastener is characterized as having a relatively low insertion force (i.e., the force required to insert the fastener into the panel opening) while maintaining a relatively high extraction force (i.e., the force required to withdraw the fastener from the panel opening).

### CROSS-REFERENCE TO RELATED APPLICATIONS

The present application claims the benefit under 35 U.S.C. 119(e) of U.S. provisional Patent Application Ser. No. 60/673,221, filed Apr. 20, 2005, the disclosure of which is incorporated herein by reference.

### BACKGROUND OF THE INVENTION

The present invention relates generally to ties and, more particularly, to ties which can be formed into a closed loop.

Ties are well known in the art and are widely used in a variety of different applications.

One tie which is well known and widely used in the art is the cable tie. Cable ties are commonly used in commerce to bundle together of a plurality of objects, such as a group of parallel wires.

One type of cable tie which is well known in the art comprises a serrated strap which is fitted to an apertured head. In use, the cable tie can be formed into closed loop by inserting the serrated strap through the apertured head. With the serrated strap inserted through the apertured head, an internal pawl, or locking tang, disposed within the apertured head lockably engages the serrations of the strap to prevent the strap from being backed out of the apertured head. In this manner, the engagement of the internal pawl onto the serrated strap secures the cable tie in its closed loop configuration.

A cable tie of the type described above is typically used in the following manner to bundle together a plurality of parallel wires. Specifically, with the plurality of wires grouped together, the strap of the cable tie is wrapped around the bundle of wires. The free end of the strap is then inserted through the apertured head so as to form a closed loop around the bundle. With the cable tie formed into a closed loop, the free end of the strap is advanced through the apertured head to cinch the cable tie strap tightly around the bundle.

In certain applications, it is often desirable to retain a group of wires bundled with a cable tie securely against a flat surface. In particular, in the automotive industry it is often desirable to retain a group of electrical wires bundled with a cable tie securely against an automotive panel so as to preclude the bundle from moving (i.e., rattling) within the automobile body during operation of the car.

Accordingly, cable ties are commonly provided with an insert fastener which can be coupled to an automotive panel. Commonly, the insert fastener is integrally formed directly onto the head of the cable tie and is sized and shaped to fittingly penetrate through an existing opening in the automotive panel. When disposed through the opening, retaining members on the insert fastener engage the automotive panel so as to secure the insert fastener in place within the panel. In this manner, the plurality of wires which are bundled together by the cable tie are, in turn, retained against the automotive panel, which is highly desirable.

Insert fasteners are commonly constructed in a variety of different configurations. One well-known type of insert fastener which is commonly formed onto the free end of a conventional cable tie is a Christmas-tree fastener (also commonly referred to in the art as a pine-tree fastener or a fir-tree fastener). Examples of cable ties which are provided with a Christmas-tree type fastener are described in U.S. Pat. No. 5,921,510 to J.C. Benoit et al. and U.S. Pat. No. 4,342,438 to R. Speedie, both of said patents being incorporated herein by reference.

Referring now to FIGS. 1(a) and 1(b), there are shown lateral cross-section and top plan views, respectively, of a fir-tree type fastener which is well-known in the art, the fastener being identified generally by reference numeral 11. Fir-tree fastener 11 includes an elongated stem 13 which includes a longitudinal axis 15. One end of elongated stem 13 is integrally formed onto the top surface of a concave flexible dish 17. The opposite end of elongated stem 13 is shaped into a rounded tip 19.

A plurality of flexible flutes 21 (also commonly referred to as retention barbs or radial wings) is integrally formed onto stem 13 along its length in an equidistantly spaced apart manner. Each flute 21 extends radially away from stem 13 at an acute angle α1 relative to longitudinal axis 15 (in the direction away from rounded tip 19) so as to provide fastener 11 with an overall design which resembles a traditional Christmas tree (wherein each flute 21 resembles a branch of the Christmas tree).

Christmas-tree fastener 11 is designed with a profile which enables it to be fittingly inserted through a circular opening O in an automotive panel P, wherein the diameter D of opening O is approximately 0.25 inches (more specifically, the diameter of opening O is in the range between 0.244 inches and 0.272 inches) and wherein panel P has a thickness T of approximately 0.059 inches. However, it is to be understood that fir-tree fasteners are commonly constructed in various shapes and sizes to allow for use in conjunction with a wide variety of different openings and/or panels, thereby increasing its range of potential applications.

Fir-tree fastener 11 is designed to be fittingly inserted through opening O in panel P in the following manner. Specifically, as seen most clearly in FIG. 1(a), rounded tip 19 of stem 13 is directed through opening O until the outermost flute 21-1 contacts panel P about the periphery of opening O. As fastener 11 is urged further through opening O, panel P causes flute 21-1 to flex inward (i.e, toward longitudinal axis 15) to such a degree so as to enable flute 21-1 to fit through opening O. Further advancement of fastener 11 through opening O similarly causes remaining flutes 21-2 through 21-7 to successively inwardly flex as they penetrate through opening O. Due to the resilient construction of flutes 21, each flute 21 outwardly flexes back to its original configuration once it passes entirely through the opening in the panel. As can be appreciated, with all of flutes 21 inserted through opening O, rearmost flute 21-7 and flexible dish 17 abut against opposing sides of panel P so as to securely retain fastener 11 in place within opening O.

As noted briefly above, each flute 21 on fastener 11 extends away from stem 13 in the direction away from rounded tip 19. It is because of this particular orientation of flutes 21 that fir-tree fastener 11 is characterized as having an insertion force (i.e., the force required to insert the fastener through the opening in the panel) which is substantially less the its extraction force (i.e., the force required to extract a mounted fastener from the opening in the panel).

In conjunction with the present invention, applicant has recognized a notable drawback associated with traditional fir-tree fasteners of the type as described above (e.g., fir tree fastener 11). Specifically, applicant has recognized that traditional fir-tree fasteners are constructed in such a manner that each flute tends to interfere with (i.e., contact) the next rearmost flute during the fastener insertion process (this condition being referred to herein simply as “flute interference”). As seen most clearly in FIG. 1(a), as fastener 11 is inserted through opening O, flute 21-1 collapses inward. However, it should be noted that flute 21-1 interferes with, or contacts, the next successive flute 21-2 before flute 21-1 has collapsed to the extent necessary to fit through opening O. As a result, in order for flute 21-1 to collapse to the extent necessary to fit through opening O, a cumulative force must be applied onto flute 21-1 which is large enough to cause flute 21-1 as well as one or more of the successive flutes (e.g., flutes 21-2, 21-3, etc.) to similarly flex to the extent necessary for fastener 11 to fit through opening O.

As can be appreciated, the above-described flute interference condition serves to significantly increase the insertion force associated with fastener 11, which is highly undesirable. In fact, it has been found that some conventional fir-tree type fasteners of a design similar to fastener 11 require an insertion force of approximately 30 to 40 pounds. In an assembly line environment (e.g., in an automotive manufacturing facility), the relatively high insertion force required for such a fastener can result in, among other things, injury to its workers (e.g., carpal tunnel syndrome), which is highly undesirable.

### SUMMARY OF THE INVENTION

It is an object of the present invention to provide a new and improved one-piece cable tie which includes a serrated strap fitted to an apertured head.

It is another object of the present invention to provide a cable tie of the type as described above which further includes a fir-tree fastener that is designed for penetration through a circular opening formed in an automotive panel.

It is yet another object of the present invention to provide a cable tie of the type as described above which includes an fir-tree fastener which requires a relatively low insertion force when being disposed through the opening in the panel.

It is still another object of the present invention to provide a cable tie of the type as described above which includes a fir-tree fastener which does not experience flute interference as the fastener is being disposed through the opening in the panel.

It is yet still another object of the present invention to provide a cable tie of the type as described above which includes a limited number of parts, which is easy to use and which is inexpensive to manufacture.

Accordingly, there is provided a fastener designed for fitted insertion through an opening in a panel, the fastener comprising (a) a stem, and (b) a plurality of flutes formed onto the stem, (c) wherein the plurality of flutes are configured so as not to interfere with one another when the fastener is fittingly inserted through the opening in the panel.

Various other features and advantages will appear from the description to follow. In the description, reference is made to the accompanying drawings which form a part thereof, and in which is shown by way of illustration, an embodiment for practicing the invention. The embodiment will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

The accompanying drawings, which are hereby incorporated into and constitute a part of this specification, illustrate an embodiment of the present invention and, together with the description, serve to explain the principles of the invention. In the drawings, wherein like reference numerals represent like parts:

FIG. 1(a) is lateral cross-sectional view of a prior art fir-tree fastener, the fastener being shown partially inserted through an opening in a panel, the panel being shown in lateral cross-section;

FIG. 1(b) is a top plan view of the prior art fir-tree fastener shown in FIG. 1(a);

FIG. 2 is a fragmentary perspective view of a cable tie constructed according to the teachings of the present invention, the cable tie including a fir-tree fastener designed for insertion through an opening in a panel;

FIG. 3 is a top plan view of the cable tie shown in FIG. 2;

FIG. 4 is a fragmentary right end view of the cable tie shown in FIG. 2;

FIG. 5 is a fragmentary front plan view of the cable tie shown in FIG. 2;

FIG. 6 is a section view of the fir-tree fastener shown in FIG. 3 taken along lines 6-6;

FIG. 7 is an enlarged section view of the fir-tree fastener shown in FIG. 6, the fastener being shown partially inserted through the opening in a panel, the panel being shown in lateral cross-section;

FIG. 8(a) is lateral cross-sectional view of the fastener shown in FIG. 2, the fastener being shown partially inserted through an opening in a panel, the panel being shown in lateral cross-section; and

FIG. 8(b) is a top plan view of the fastener shown in FIG. 2.

### DETAILED DESCRIPTION OF A PREFERRED EMBODIMENT

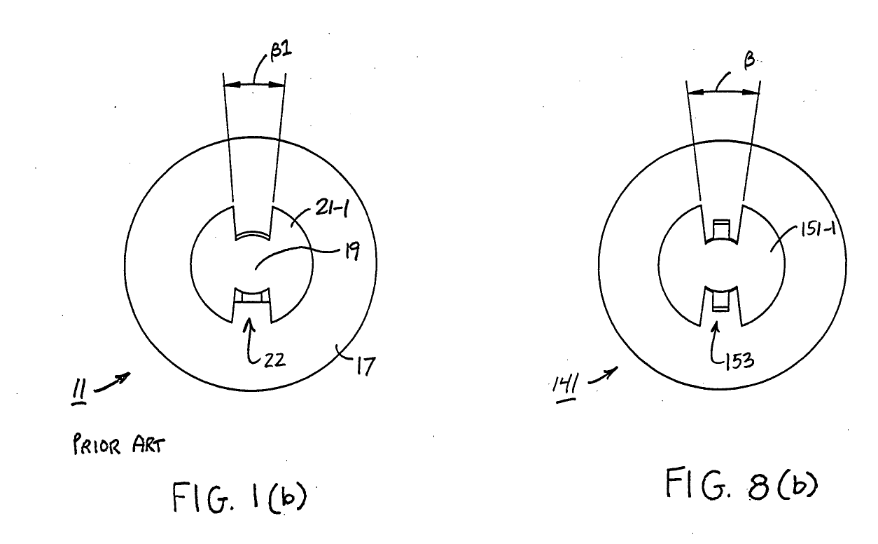

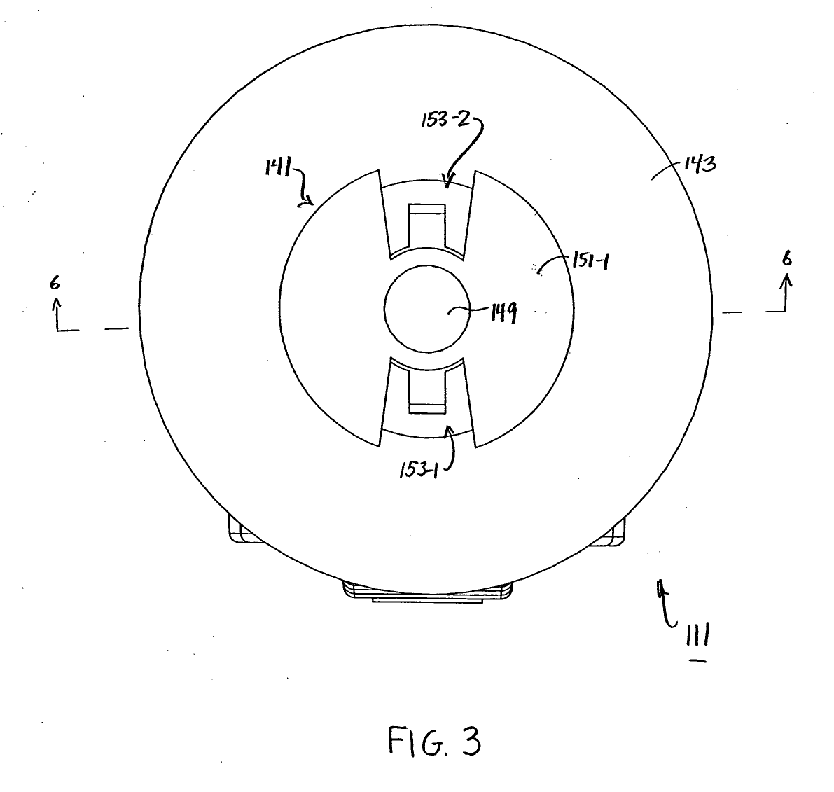

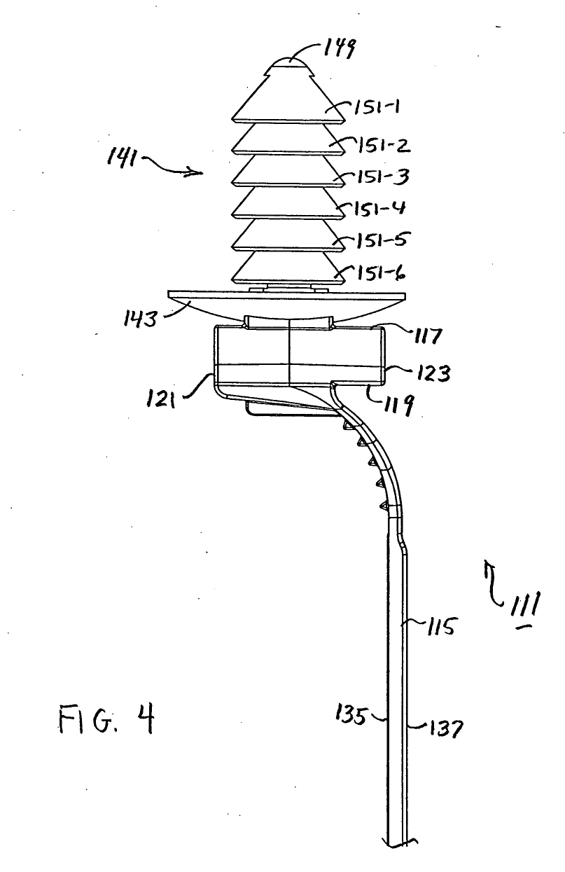

Referring now to FIGS. 2-5, there is shown a cable tie (also referred to herein simply as a tie) which is constructed according to the teachings of the present invention, the tie being identified generally as reference numeral 111. As one of its potential applications, tie 111 can be used to bundle together a group of wires and, in turn, retain said bundle against an automotive panel.

Cable tie 111 comprises a locking head 113 and an attached strap 115. Preferably, tie 111 is manufactured of a plastic material, such as nylon, and is formed as a single piece using conventional molding techniques.

Locking head 113 is generally rectangular in shape and comprises a top wall 117, a bottom wall 119, a front wall 121, a rear wall 123, a first side wall 125 and a second side wall 127. Together, top wall 117, bottom wall 119, front wall 121, rear wall 123, first side wall 125 and second side wall 127 define a strap accepting channel 129 which extends longitudinally through head 113 (i.e., from front wall 121 to rear wall 123).

Locking head 113 is shaped to include a pivotable locking pawl, or tang, 131 which projects into strap accepting channel 129. As can be appreciated, with strap 115 inserted into channel 129, locking pawl 131 is designed to engage strap 115 to secure tie 111 in its closed loop configuration.

Strap 115 is an elongated flexible member which is generally uniform and rectangular in lateral cross-section. However, it is to be understood that strap 115 could be constructed in alternative sizes and shapes without departing from the spirit of the present invention.

Strap 115 comprises a first end 133, a second end (not shown), a front surface 135 and a rear surface 137. First end 133 of strap 115 is integrally connected to bottom wall 119 of head 113 so as to render tie 111 a unitary device. Strap 115 further includes a plurality of ratchet-shaped teeth 139 formed along the length of front surface 135, teeth 139 being adapted to be engaged by locking pawl 131 when tie 111 is formed into a closed loop.

Cable tie 111 additionally includes a one-piece Christmas-tree type fastener 141 which is integrally formed onto top wall 117 of locking head 113. As will be described in detail below, Christmas-tree fastener 141 (also referred to herein as fastener 141, pine-tree fastener 141 or fir-tree fastener 141) is sized and shaped to be securely retained within a circular opening O formed into an automotive panel P. It should be noted that the particular design of fastener 141 serves as the principal novel feature of the present invention.

Fastener 141 includes a concave flexible dish 143 which is integrally formed onto top wall 117 of locking head 113. Dish 143 serves as a support against the underside of panel P when fastener 141 is inserted through opening O.

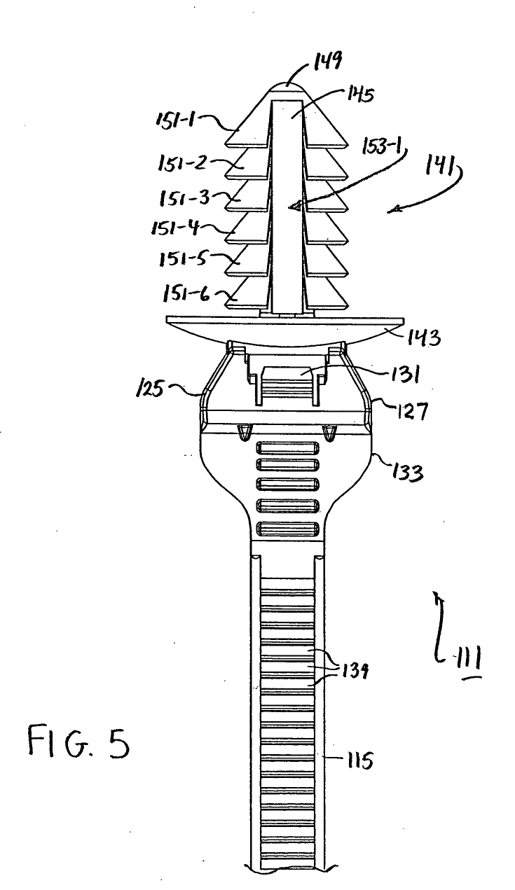

Fastener 141 also includes an elongated stem 145 which has a longitudinal axis 147, as seen most clearly in FIG. 6. Stem 145 is integrally formed, at one end, onto dish 143 at the approximate midpoint of its top surface. Stem 145 extends orthogonally away from dish 143, the free end of stem 145 being shaped in the form of a rounded tip 149 .

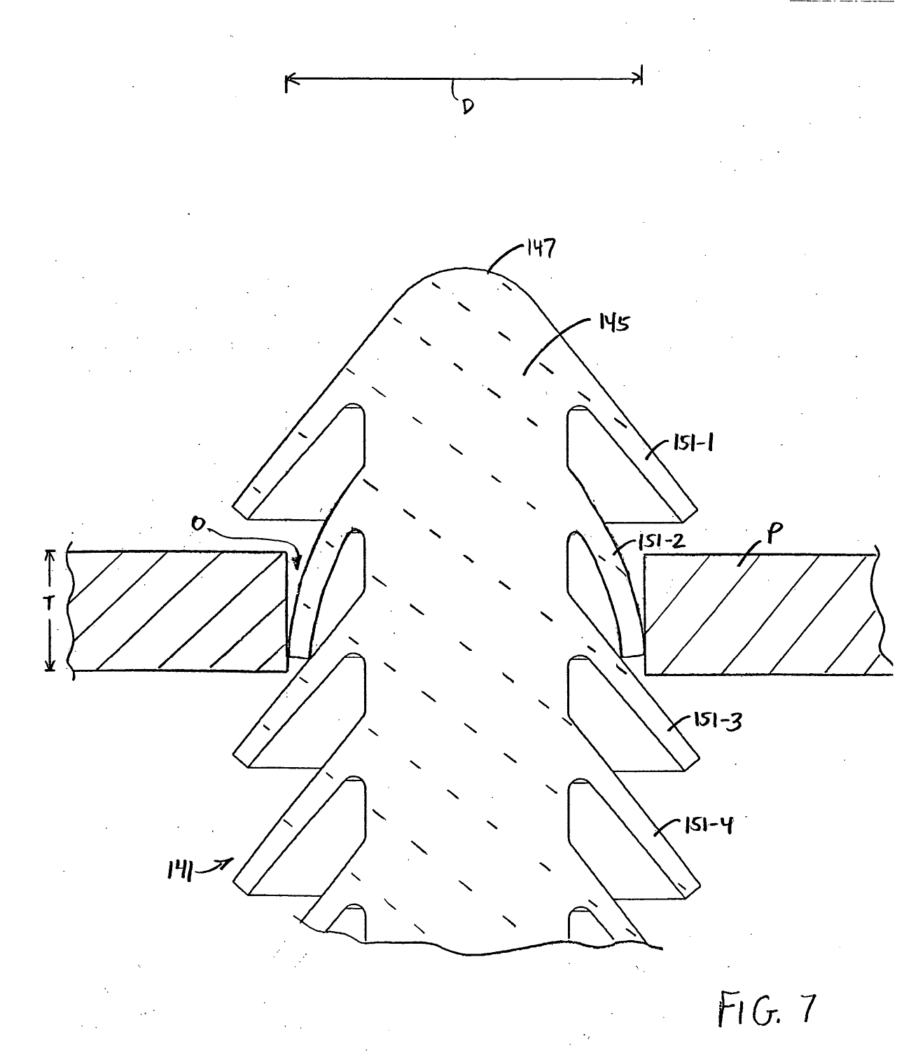

A plurality of flexible flutes 151 (also referred to herein as retention barbs or radial wings) is integrally formed onto elongated stem 145 along its length in an equidistantly spaced apart manner. As seen most clearly in FIG. 8(a), each flexible flute 151 extends radially away from stem 145 at an acute angle a relative to longitudinal axis 147 (in the direction away from rounded tip 149) so as to provide fastener 141 with an overall design which resembles a traditional Christmas tree.

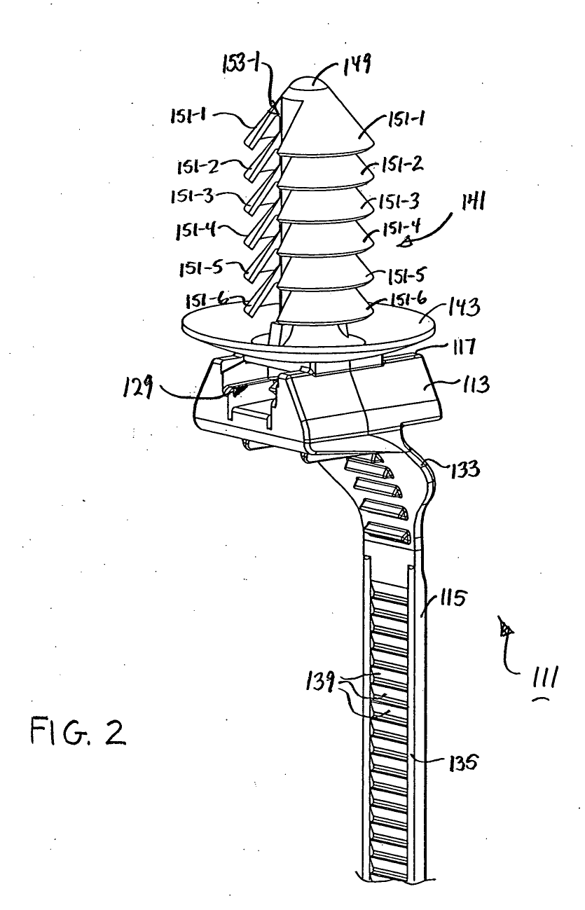

It should be noted that a pair of opposing vertical cut-outs 153-1 and 153-2 is formed into flutes 151 approximately 180 degrees apart from one another, as seen most clearly in FIGS. 2 and 3. Cut-outs 153 are formed into flutes 151 to facilitate the compression of flutes 151 upon the application of a suitable inward force thereon.

As can be appreciated, fir-tree fastener 141 shares a similar design with prior art fastener 11. However, as will be described further in detail below, the principal distinction between fastener 141 and fastener 11 lies in the fact that fir-tree fastener 141 does not experience flute interference when inserted through opening O in panel P, whereas prior art fastener 11 does experience flute interference when inserted through opening O in panel P.

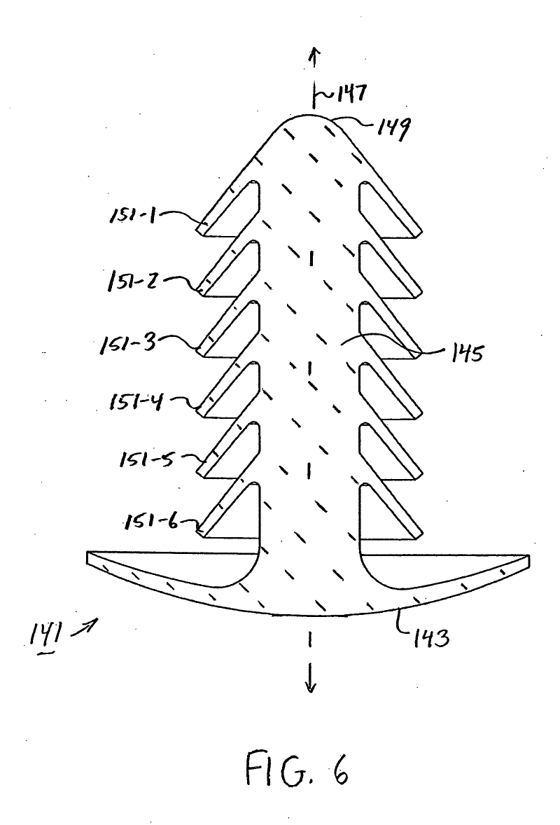

FIG. 7 clearly depicts the manner in which fir-tree fastener 141 avoids flute interference when disposed through circular opening O in panel P (wherein the diameter D of opening O is in the range of 0.244 inches and 0.272 inches and wherein panel P has a thickness T of approximately 0.059 inches). Specifically, as shown in the drawing, fastener 141 is configured such that flute 151-2 does not substantially contact the next successive flute 151-3 until flute 151-2 has collapsed to the extent necessary to fit through opening O. The remaining flutes 151 are similarly configured so as to provide fir-tree fastener 141 with its interference-free construction. As a result, it is to be understood that fastener 141 (i) has a considerably lower insertion force than prior art fastener 11 while (ii) retaining substantially the same extraction force as prior art fastener 11, which is a principal object of the present invention.

Fir-tree fastener 141 differs in construction from fir-tree fastener 11 in four principal ways which together serve to eliminate/minimize the occurrence of flute interference in fastener 141. The four principal design modifications (i.e., optimizations) are as follows:

(1) Increased Flute Pitch:

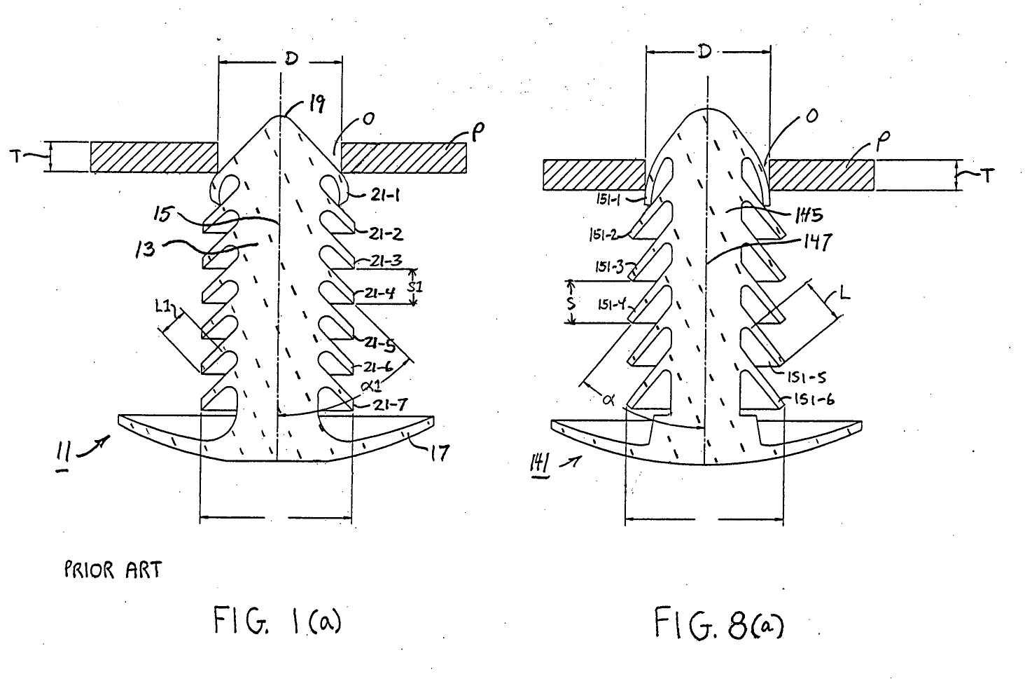

As seen most clearly in Figs. 1(a) and 8(a), the spacing S, or pitch, between successive flutes 151 in fir-tree fastener 141 is substantially greater than the spacing S1, or pitch, between successive flutes 21 in prior art fastener 11. Specifically, the pitch S between successive flutes 151 in fir-tree fastener 141 is approximately 0.085 inches. To the contrary, the pitch S1 between successive flutes 21 in prior art fastener 11 is approximately 0.071 inches.

(2) Decreased Flute Angle:

As seen most clearly in Figs. 1(a) and 8(a), the angle α which each flute 151 extends away from stem 145 in fir-tree fastener 141 is substantially less than the angle α1 which each flute 21 extends away from stem 13 in prior art fastener 11. Specifically, for fir-tree fastener 141, the angle a which each flute 151 extends away from longitudinal axis 147 of stem 145 is approximately 40 degrees. To the contrary, for prior art fastener 11, the angle α1 which each flute 21 extends away from longitudinal axis 15 of stem 13 is approximately 46 degrees.

(3) Increased Flute Length:

As seen most clearly in Figs. 1(a) and 8(a), the length L of each flute 151 in fir-tree fastener 141 is substantially greater than the length L1 of each flute 21 in prior art fastener 11. Specifically, the length L of each flute 151 in fir-tree fastener 141 is approximately 0.095 inches. To the contrary, the length L1 of each flute 21 in prior art fastener 11 is approximately 0.060 inches.

(4) Increased Cut-Out Angle:

As seen most clearly in Figs. 1(b) and 8(b), the cut-out angle β formed in flutes 151 of fir-tree fastener 141 is substantially greater than the cut-out angle β1 formed in flutes 21 of prior art fastener 11. Specifically, the angle β of each cut-out 153 formed in flutes 151 of fir-tree fastener 141 is approximately 15 degrees. To the contrary, the angle β1 of each cut-out 22 formed in flutes 21 of prior art fastener 11 is approximately 10 degrees.

It should also be noted that the number of flutes 151 in fir-tree fastener 141 is less than the number of flutes 21 in fir-tree fastener 11. Specifically, fir-tree fastener 141 has six flutes whereas prior art fastener 11 has seven flutes 21. As can be appreciated, the number of flutes 151 in fir-tree fastener 141 was reduced so as to render the overall length of fastener 141 substantially the same as the overall length of fastener 11.

The embodiment of the present invention described above is intended to be merely exemplary and those skilled in the art shall be able to make numerous variations and modifications to them without departing from the spirit of the present invention. All such variations and modifications are intended to be within the scope of the present invention as defined in the appended claims.

What is claimed is:

1. A fastener designed for fitted insertion through an opening in a panel, the fastener comprising:
(a) a stem, and
(b) a plurality of flutes formed onto the stem,
(c) wherein the plurality of flutes are configured so as not to interfere with one another when the fastener is fittingly inserted through the opening in the panel.

2. The fastener as claimed in claim 1 wherein the opening in the panel is circular in shape.

3. The fastener as claimed in claim 2 wherein the circular opening has a diameter of approximately 0.25 inches.

4. The fastener as claimed in claim 2 wherein the circular opening has a diameter in the range between 0.244 inches and 0.272 inches.

5. The fastener as claimed in claim 2 wherein the plurality of flutes are formed along the length of the stem in a spaced apart relationship.

6. The fastener as claimed in claim 5 wherein the spacing between successive flutes on the stem is approximately 0.085 inches.

7. The fastener as claimed in claim 2 wherein the stem has a longitudinal axis.

8. The fastener as claimed in claim 7 wherein the angle which each flute extends away from the longitudinal axis of the stem is approximately 40 degrees.

9. The fastener as claimed in claim 2 wherein the length of each of the plurality of flutes is approximately 0.095 inches.

10. The fastener as claimed in claim 2 wherein at least one longitudinal cut-out is formed into the plurality of flutes.

11. The fastener as claimed in claim 10 wherein the angle of the at least one longitudinal cut-out is approximately 15 degrees.

12. The fastener as claimed in claim 2 wherein said fastener is constructed out of plastic.

13. The fastener as claimed in claim 12 wherein said fastener is constructed as a single piece.

14. The fastener as claimed in claim 2 wherein said fastener is coupled to a cable tie.

15. The fastener as claimed in claim 14 wherein said cable tie comprises:
(a) a head shaped to include an elongated strap accepting channel, the strap accepting channel having a longitudinal axis, said head comprising a locking member which is disposed to project into the strap accepting channel, and
(b) a strap having a first end and a second end, the first end being formed onto said head, said strap being sized and shaped to be inserted into the strap accepting channel so said cable tie forms a closed loop, said strap being adapted to be engaged by said locking member when said cable tie is formed into a closed loop.
